(19) United States
(12) Patent Application Publication
(10) Pub. No.: US 2016/0196579 A1
(43) Pub. Date: Jul. 7, 2016

(54) DYNAMIC DEEP LINKS BASED ON USER ACTIVITY OF A PARTICULAR USER

(71) Applicant: ProGrids, LLC, Campbell, CA (US)

(72) Inventors: Paul Koura, Foster City, CA (US); Jacob Chapman, Alameda, CA (US); Janghwan Lee, Sunnyvale, CA (US)

(21) Appl. No.: 14/589,804

(22) Filed: Jan. 5, 2015

(51) Int. Cl. G06Q 30/02

(52) U.S. Cl. CPC G06Q 30/0255; G06Q 30/0275

(57) ABSTRACT

Systems and methods are disclosed for dynamically providing deep links based on user activity. In one implementation, a processing device determines that an initial deep link is included in publisher digital content to be provided to a user by a publisher. The initial deep link specifies an item. The processing device determine a subset of vendors, from a group of vendors, that provide vendor digital content that enables the user to purchase the item. The group of vendors has a relationship with a deep link provider. The processing device selects one of the subset of vendors based on a history of activity of the user accessing the vendor digital content of the subset of vendors and provides a user-based deep link for the publisher digital content. The user-based deep link directs the user to the vendor digital content of the selected vendor.

### TECHNICAL FIELD

The present disclosure relates to deep links and, more particularly, to dynamically providing a deep link based on user activity of a particular user.

### BACKGROUND

Online publishers provide online publications, for example, in the form of online newspapers, online magazine, online blogs, and the like. The online publishers typically host and/or otherwise provide websites and/or mobile applications for users to access the online publications. Often times, the online publications describe items, such as products or product categories which users can purchase. For example, a fashion, style and beauty website may post an online article about a new type of skin care routine, and the online article may mention a particular facial cleanser.

The online article can include text that describes the particular facial cleanser, as well as, a deep link for the particular facial cleanser. A deep link is a hyperlink to a specific piece of digital content, such as, a hyperlink to a specific web page of a certain retailer website that offers the particular facial cleanser for sale. The deep link could also direct a user to category pages, related content, a homepage, a product page for a similar or related product, or other content that is determined to be of value. Traditionally, the online publisher pre-determines which retailer to use for the deep link and inserts a static deep link in the online article. Users that access the online article and click the deep link are directed to the specific web page of the certain retailer as an opportunity to purchase or learn more about the product. If a user purchases the product as a result of clicking the deep link in the online article, the online publisher can receive credit and/or compensation for the user's purchase. A user, however, may choose not to purchase the product for a variety of reasons, for example, if the user is not familiar with the retailer that is specified the deep link.

### BRIEF DESCRIPTION OF THE DRAWINGS

The present disclosure will be understood more fully from the detailed description given below and from the accompanying drawings of various implementations of the disclosure.

FIG. 1 depicts illustrative system architecture for dynamically providing a deep link based on user activity of a particular user, in accordance with one or more aspects of the present disclosure.

FIG. 2 depicts illustrative system architecture for dynamically providing a deep link based on user activity of a particular user, in accordance with one or more aspects of the present disclosure.

FIG. 3 is a flow diagram of an implementation of a method for dynamically providing deep links based on user activity of a particular user, in accordance with one or more aspects of the present disclosure.

FIG. 4 is a block diagram for dynamically providing deep links based on user activity of a particular user, in accordance with one or more aspects of the present disclosure.

FIG. 5 is a flow diagram of an implementation of a method for selecting an in-network vendor based on user activity of a particular user, in accordance with one or more aspects of the present disclosure.

FIG. 6 is a block diagram of an example computer system that may perform one or more of the operations described herein, in accordance with various implementations.

### DETAILED DESCRIPTION

Aspects and implementations of the present disclosure are directed to dynamically providing a deep link based on user activity of a particular user. A deep link is a hyperlink to a specific piece of digital content. The specific digital content can be, for example, but not limited to, a particular web page of a website for a particular item or a particular location in a mobile application (“app”) for a particular item. In one example, the mobile app is a vendor mobile app that offers the particular item for sale via the mobile app. In another example, the mobile app is an app store that offers various applications and the particular item for sale. Deep links can also direct users to specific product category web pages, or specific website content, such as a pop-up or other content element on a webpage (as opposed to the more general content of a homepage). Whereas, a link can direct a user to general digital content, such as the homepage of a website or a starting location of a mobile app that is executing. For example, the deep link may be http://example.com/path/page and a link may be http://example.com. For example, a deep link, when clicked, can direct an end-user to a specific product web page, which allows the end-user to purchase the specific product, and a link may direct the end-user to a homepage of the vendor that sells the product.

A deep link can be found, for example, in a blog post, an online article, etc. For example, a fashion magazine publisher may have a website that includes an online article describing the editor's picks for beauty products for the fall season. The online article may include a deep link to a specific nail polish product (e.g., Deborah Lippmann™ nail polish “Baby Love”). The nail polish product may be for sale on a vendor's website. For example, the cosmetic vendor Sephoral may offer the nail polish product for sale on its website. The deep link in the online article may direct end-users that are accessing the article to the specific nail polish product web page in the Sephoral website to purchase the nail polish product.

If an end user purchases the product as a result of clicking the deep link in the online article, the fashion magazine publisher can receive credit and/or compensation for the user's purchase. A user, however, may not purchase the product for a variety of reasons, for example, if the user is not familiar with the vendor, which is selling the product, which is specified by the deep link. Accordingly, contrary to conventional solutions, which provide static deep links in publisher content, regardless of which end-user is accessing the publisher content, implementations of the present disclosure dynamically provide a user-based deep link, which is created for a particular user, to be included in the publisher content. Implementations of the present disclosure can create a custom deep link for a specific user based on the particular user's online activity and/or one or more characteristics of the particular user to increase the likelihood that the particular user will purchase a product that is specified by the deep link.

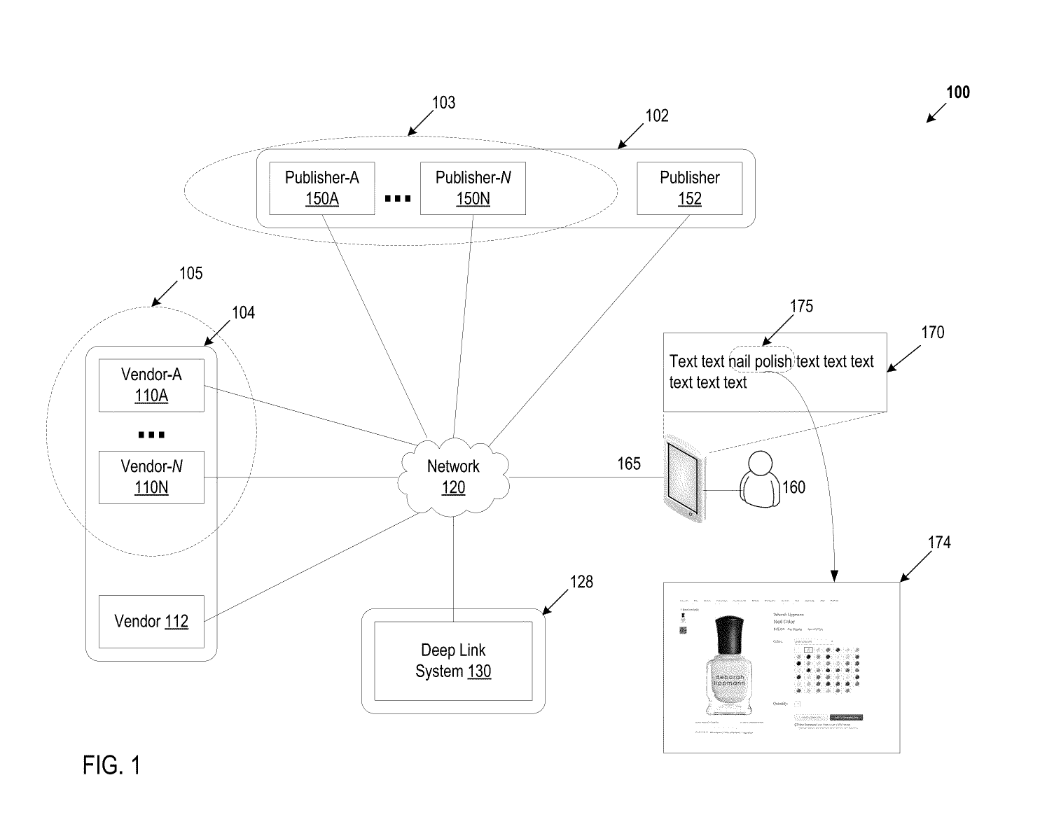

FIG. 1 depicts illustrative system architecture 100 for dynamically providing a deep link based on user activity and/or one or more characteristics of a particular user, in accordance with one or more aspects of the present disclosure. The system architecture 100 includes one or more client devices 165, one or more vendors 104, one or more publishers 102, and a deep link provider 128. These various elements or components of the system architecture 100 can be connected to one another via one or more networks 120. The one or more networks 120 can include one or more public networks (e.g., the Internet), one or more private networks (e.g., a local area network (LAN) or one or more wide area networks (WAN)), one or more wired networks (e.g., Ethernet network), one or more wireless networks (e.g., an 802.11 network or a Wi-Fi network), one or more cellular networks (e.g., a Long Term Evolution (LTE) network), routers, hubs, switches, server computers, and/or a combination thereof.

Publishers 102 can include any entities that generate, maintain, provide, present and/or otherwise process content. The term “content” or “digital content” refers to various types of application-based (e.g., web application based, mobile app based), and/or otherwise presented information, such as articles, social media postings, blog posts, discussion threads, reports, analyses, coupons, financial statements, music, video, graphics, search results, web page listings, information feeds (e.g., RSS feeds), television broadcasts, radio broadcasts, online publications, etc. In some implementations, the publishers 102 may include content providers with an Internet presence, such as online publication and news providers (e. g., online newspapers, online magazines, television websites, etc.), online service providers (e. g., financial service providers, health service providers, etc.), bloggers, and the like. The publishers 102 can include television broadcasters, radio broadcasters, satellite broad casters, and other content providers.

The publishers 102 may receive requests from the users (e.g., user 160) via client devices (e.g., client device 165) for publisher digital content and provide or present the publisher digital content to the requesting client devices. Using the example discussed above, Publisher-A 150A may be a fashion magazine publisher that hosts a website that includes an online article 170 describing the editor's picks for beauty products for the fall season, which user 160 can access via client device 165. The online article 170 may include text that describes a specific nail polish product (e.g., Deborah Lippmann™ Baby Love nail polish).

The publishers 102 may provide or present content via various mediums and in various forms, including application-based (e.g., web application based) and mobile app based mediums and forms. The publishers 102 may generate and/or maintain such content and/or retrieve the content from other network resources. Each of the publishers 102 can include one or more application servers that provide web applications and/or mobile device applications and data for the applications. The application servers can be hosted on computing machines, such as, and not limited to, rackmount servers, personal computing machines, desktop computing machine, media centers, cloud servers, or any combination of the above.

Vendors 104 can be entities (e.g., retailers, companies, suppliers, persons, wholesalers, manufacturers, distributors, etc.) that sell one or more products and/or services. Vendors 104 can host digital content, such as a website and a mobile application, to offer various items (e.g., products and/or services). For example, Vendor-A 110A may be retailer Nordstram, Inc. and may host a website www.nordstram.com and/or a mobile application Nordstram App to sell various items (e.g., clothing, accessories, cosmetics, etc.). Vendor-A 110 can provide vendor digital content (e.g., web page, mobile app) that allows a user 160 to purchase a specific nail polish product (e.g., Deborah Lippmann™ Baby Love nail polish).

Each of the vendors 104 can include one or more application servers that provide web applications and/or mobile device applications and data for the applications. The application servers can be hosted on computing machines, such as, and not limited to, rackmount servers, personal computing machines, desktop computing machine, media centers, cloud servers, or any combination of the above.

The one or more client devices 165 can be user devices. The client devices 165 can be wireless terminals (e.g., smartphones, etc.), personal computers (PC), personal digital assistants (PDAs), a wearable computing device (e.g. smartwatch, etc.), portable media players, netbooks, laptop computers, an electronic book reader or a tablet computer (e.g., that includes a book reader application), a set-top box, a gaming console, a television, smart television, or any other computing or communication devices. The client devices 165 can be geographically distributed anywhere throughout the world.

The client devices 165 can run an operating system (OS) that manages hardware and software of the client devices 165. Various applications, such as mobile apps, web browsers, etc. (not shown) can run on the client devices 165 (e.g., on the OS of the client devices) for accessing publisher digital content and vendor digital content. For example, the client device 165 can include a web browser to access websites, including web pages, of publishers 102 and vendors 104. In another example, the client device 165 can include mobile apps of publishers 102 and vendors 104.

The publisher digital content (e.g., online article 170) provided by the publishers 102 (e.g., Publisher-A 150A) can include one or more deep links. A deep link is a reference (e.g., hyperlink) to a specific piece of digital content, which when selected (e.g., clicked, hovered over, touch, etc.) can direct an end-user to the specific piece of digital content. The piece of digital content can be, for example, and not limited to, specific content of a website (e.g., particular web page of the website), specific content of a mobile app (e.g., specific location in a mobile app), a category web page of a website, specific website content related to a particular item, a homepage of a website, a product page for a similar item or related product, or other content that may be determined to be of value to a particular user, etc. A website is a collection of web pages, and in one example, a deep link can direct a user (e.g., user 460) to a specific web page and/or direct the user to a specific location on a specific web page. A mobile app is a computer program that can be run on a mobile device (e.g., smartphone, tablet computer, etc.), and in one example, a deep link can direct a user to a specific location in the mobile app that is executing.

For example, a user 160 can access the online article 170, which describes the editor's picks for beauty products for the fall season, via client device 165. The online article 170 can describe a specific nail polish product (e.g., Deborah Lippmann™ Baby Love nail polish). The nail polish product may be for sale by one or more vendors 104. The online article 170 can include a deep link 175 to a particular web page or mobile app of one of the vendors 104 that allows the user to purchase the nail polish product.

Unlike conventional solutions that provide the same static deep link in publisher digital content for all users, implementations of the present disclosure include a deep link provider 128 that dynamically provides a deep link (e.g., deep link 175) for the publisher digital content (e.g., online article) customized for an individual user 160 and/or group of users.

The deep link provider 128 can include a deep link system 130 to determine which vendor 104 to use for the deep link 175 for the particular user 160 and/or group of users. A subset 105 of the vendors 104 can represent a deep link network that is associated with the deep link provider 128. In one example, the deep link network is made up of the subset 105 of vendors 104 that have a business relationship with the deep link provider 128. For example, the deep link provider 128 may have a relationship with Vendor-A 110A to Vendor-N 110N and not with Vendor 112. Vendors (e.g., Vendor-A 110A to Vendor-N 110N) that have a relationship with the deep link provider 128 are hereinafter referred to “in-network” vendors and vendors (e.g., Vendor 112) that do not have a relationship with the deep link provider 128 are hereinafter referred to “out-of-network” vendors throughout this document.

A subset 103 of the publishers 102 can also represent the deep link network that is associated with the deep link provider 128. In one example, the deep link network is also made up of the subset 103 of the publishers 102 that have a business relationship with the deep link provider 128. For example, the deep link provider 128 may have a relationship with Publisher-A 150A to Publisher-N 150N and not with Publisher 152. Publishers (e.g., Publisher-A 150A to Publisher-N 150N) that have a relationship with the deep link provider 128 are hereinafter referred to “in-network” publishers and publishers (e.g., Publisher 152) that do not have a relationship with the deep link provider 128 are hereinafter referred to “out-of-network” publishers throughout this document.

The deep link provider 128 can include a deep link system 130 to determine which in-network vendor to use for causing the deep link 175 to be a user-based deep link for the particular user 160 and/or group of users. A user-based deep link is a deep link customized for a particular user, for example, based on a history of activity of the particular user who is accessing the vendor digital content of the in-network vendors. A user-based deep link can also be a deep link customized for a particular group of users, for example, based on a history of activity of the particular users who are accessing the vendor digital content of the in-network vendors. The deep link system 130 can include one or more deep link servers and tracking servers that dynamically provide user-based deep links based on user activity and/or one or more characteristics of the user(s). The deep link servers and tracking servers can be hosted on computing machines, such as, and not limited to, rackmount servers, personal computing machines, desktop computing machine, media centers, cloud servers, or any combination of the above.

One or more of the in-network vendors may provide vendor digital content (e.g., web page, mobile app) that enables the user 160 to purchase the item (e.g., nail polish product). For example, the nail polish product (e.g., Deborah Lippmann™ Baby Love nail polish) that is described in the publisher online article 170 may be for sale by two in-network vendors (e.g., Vendor-A 110A and Vendor-N 110N). The deep link system 130 can use criteria and data pertaining to the particular user 160 and/or group of users to determine which of the two in-network vendors (e.g., Vendor-A 110A and Vendor-N 110N) to use for the deep link 175. For example, the deep link system 130 may determine that user 160 purchased an item from Vendor-A 110A more recently than from Vendor-N 110N and may configure the deep link 175 to a user-based deep link that directs the user 160 to the vendor digital content 174 (e.g., web page, mobile app) of Vendor-A 110A, allowing the user 160 to purchase the item (e.g., nail polish product) from the in-network vendor (e.g., Vendor-A 110A) that the user 160 is already familiar with. When the user 160 selects the user-based deep link 175, the user 160 is directed to the vendor digital content 174 (e.g., web page, mobile app) of Vendor-A 110A. In another example, the deep link system may determine that a particular groups of users may have accessed the website and/or mobile app of Vendor-A 110A in the last 12 hours and may configure the deep link 175 to a user-based deep link that directs the group of users to the vendor digital content 174 of Vendor-A 110A.

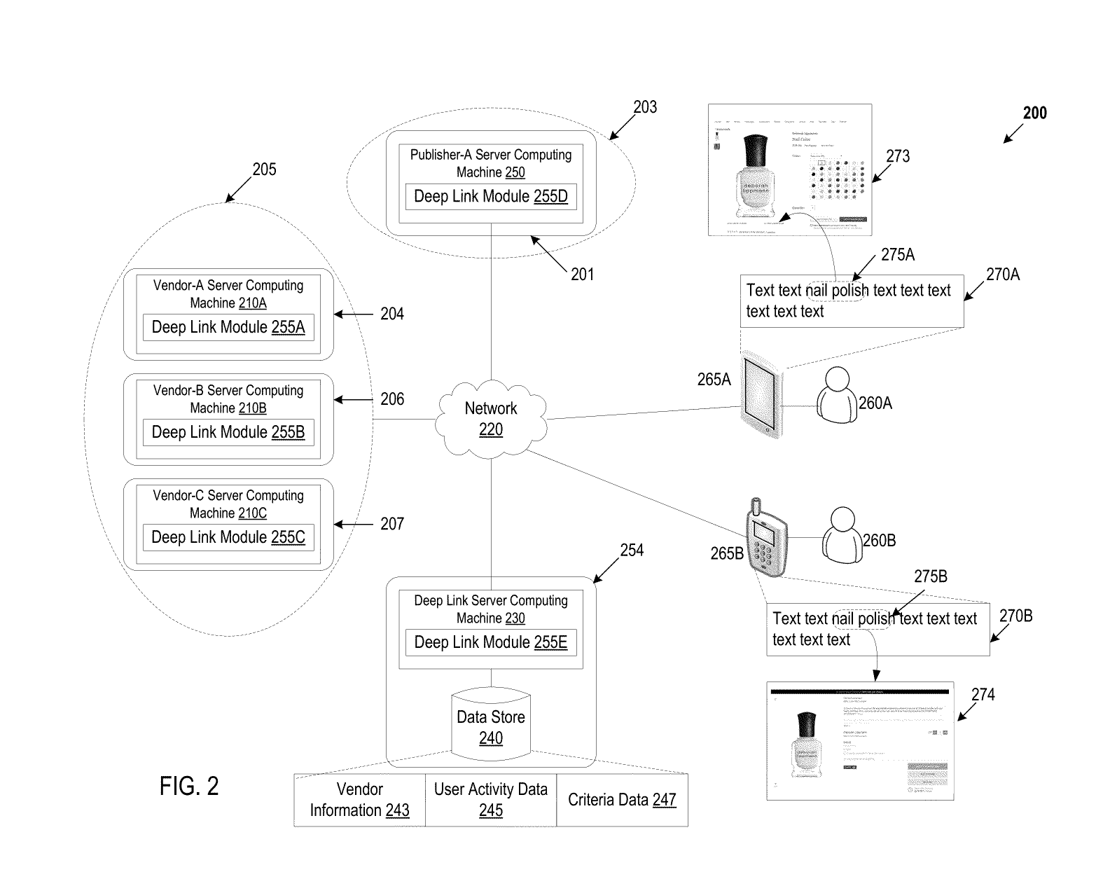

FIG. 2 depicts illustrative system architecture 200 for dynamically providing a deep link based on user activity of a particular user, in accordance with one or more aspects of the present disclosure. The system architecture 200 includes in-network publishers 203, in-network vendors 205, deep link provider 254, and client devices 260A-B coupled to one another via one or more networks 220.

The in-network publishers 203 can include Publisher-A 201. It should be noted that although one in-network publisher (e.g., Publisher-A 201) is illustrated, there may be more than one in-network publisher. Publisher-A 201 can have one or more application servers (e.g., server computing machine 250) that provide web applications and/or mobile device applications and data for the applications for providing publisher digital content (e.g., web pages, mobile apps) to users 260A-B via client devices 265A-B.

The in-network vendors 205 can include Vendor-A 204 (e.g. Nordstram, Inc.), Vendor-B 206 (e.g., Neimint Sparkus), and Vendor-C 207 (e.g., Mazy's). It should be noted that although three in-network vendors 204,206,207 are illustrated, there may be more or less in-network vendors. Each vendor can have one or more application servers that provide web applications and/or mobile device applications and data for the applications for providing vendor digital content (e.g., web pages, mobile apps) to users 260A-B via client devices 265A-B.

The in-network vendors 205 can receive requests from the users 260A-B via client devices 265A-B for vendor digital content (e.g., web pages, mobile apps), and the in-network vendors 205 can provide or present the vendor digital content to the requesting client devices 265A-B. For example, Vendor-A 204 may be retailer Nordstram, Inc. and may host a website www.nordstram.com and/or a mobile app Nordstram App to sell various products (e.g., clothing, accessories, cosmetics, etc.), and user 260A may have purchased a clothing item the website and/or mobile app of Vendor-A 204 within the last two days. User 260A may have not accessed any vendor digital content from Vendor-B 206 or Vendor-C 207 within the last two days.

In another example, Vendor-B 206 may be retailer Neimint Sparkus and may host a website www.neimintsparkus.com and/or a mobile app Neimint Sparkus App to sell various products (e.g., clothing, accessories, cosmetics, etc.), and user 260B may have visited the website and/or mobile app of Vendor-B 206 multiple times within the last week. User 260B may have not accessed any vendor digital content from Vendor-A 204 or Vendor-C 7 within the last week.

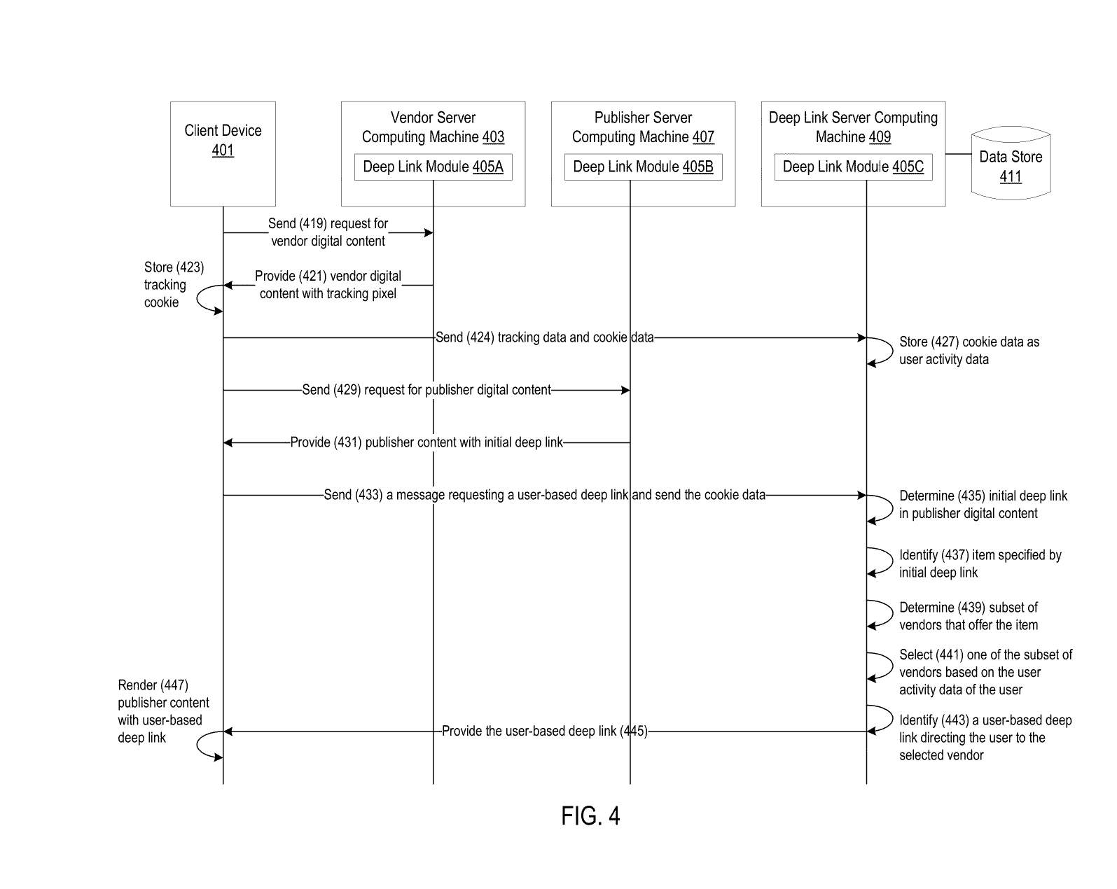

When users 260A-B access the vendor digital content of in-network vendors 205, the deep link module 255 of the respective vendor can implement a tracking pixel for a particular user accessing the vendor digital content, which can be used to generate user activity data 245 for the respective users 260A-B. The generation and storing of the user activity data 245 is described in greater detail below in conjunction with FIG. 4. Referring back to FIG. 2, the user activity data 245 can be stored in one or more data stores 240. The user activity data 245 can include data for multiple users 260. The user activity data 245 can include multiple entries for each user 260. Each entry in the user activity data 245 can correspond to a session of a user 260 accessing vendor digital content (e.g., web page, mobile app). A session can be an interactive information interchange, also known as a dialogue, a conversation or a meeting, between two or more communicating devices. A session is set up or established at a certain point in time, and then ended at some later point. An established communication session may involve more than one message in each direction. Each entry can include the unique identifier of a respective user, the identifier of the digital content accessed by the respective user, session identifier for the particular session, session timestamp for the particular session, and data indicating whether a purchase was made during the particular session. The user activity data 245 can also include, can be combined with, other user characteristic data. Examples of user characteristic data can include, and are not limited to demographic data for one or more users, in market data for one or more users, interest data for one or more users, affinity data for one or more users, and buyer/shopper user model data. The user activity data 245 can be used to determine one or more characteristic data.

“In market data” is any data that indicates whether a user is in active-consideration mode and wants to make a purchase. “Affinity data” is any data that indicates a portfolio of individuals' likes and dislikes based on the online content that the user interacts with. “Interest data” is any data that one or more users can provide that indicate the interests of the respective user. “Buyer/shopper user model data” is any data that can used to determine whether one or more users fit a particular buyer/shopper user model.

Publisher-A 201 may receive requests from the users 260A-B via client devices 265A-B for publisher digital content (e.g., web pages, mobile apps), and Publisher-A 201 can provide or present the publisher digital content to the requesting client devices 265A-B. Using the example discussed above, Publisher-A 201 may be a fashion magazine publisher that hosts a website that includes an online article 270A-B describing the editor's picks for beauty products for the fall season, which users 260A-B can access via client devices 265A-B. The online article 270A-B can describe a specific nail polish product (e.g., Deborah Lippmann™ Baby Love nail polish). The nail polish product or an identified similar product may be for sale by one or more in-network vendors 205. The online article 270A-B can include a deep link 275A-B pointing to a particular web page or location within a mobile app of one of the in-network vendors 205 that allows the users 260A-B to purchase the nail polish product or a product similar to the particular nail product.

The deep link provider 254 can include a deep link server computing machine 230 coupled to one or more data stores 240 to provide each user 260 with a user-based deep link 275 that is customized to a respective user 260. The deep link server computing machine 230, vendor server computing machines 210A-C, and publisher server computing machine 250 can include a respective deep link module 255A-E for dynamically providing a deep link for a particular user based on user activity of the particular user.

When a user (e.g., user 260A) is requesting access to publisher digital content (e.g., online article 270A) of an in-network publisher (e.g., Publisher-A 201), the deep link module 255E of the deep link provider 254 can detect that user 260A is requesting access to the online article 270A, which includes deep link 275A for purchasing a specific nail polish product (e.g., Deborah Lippmann™ Baby Love nail polish). The deep link module 255E of the deep link provider 254 can also determine that another user, user 260B, is requesting access to the same online article 270B, which includes deep link 275B for purchasing the same nail polish product.

The deep link module 255E of the deep link provider 254 can access vendor information 243 that is stored in a data store 240 to determine which of the in-network vendors 205 offer the specific nail polish product (e.g., Deborah Lippmann™ Baby Love nail polish) for sale via web page and/or mobile app. The vendor information 243 can include information for the in-network vendors 205. The vendor information 243 can include item identifiers of items which the in-network vendors 205 offer for sale, for example, via a web page or a mobile app of a respective vendor.

For each user 260A-B that is requesting access to publisher digital content (e.g., online article 275A-B) of an in-network publisher 203, the deep link module 255E of the deep link provider 254 can select one of the in-network vendors 205 that provide a web page and/or mobile app that offers the specific product (e.g., nail polish product), or a similar product, for sale based on a history of activity of a respective user 260A-B accessing the vendor digital content (e.g., web pages, mobile apps) of the in-network vendors 205 and/or other characteristic data pertaining to the respective user 260A-B (e.g., demographic data, in market data, interest data, affinity data, and buyer/shopper user model data).

For example, the deep link module 255E of the deep link provider 254 may determine that user 260A purchased a clothing item from the website and/or mobile app of Vendor-A 204 (e.g., Nordstram, Inc.) within the last two days and can cause deep link 275A for user 260A to direct user 260A to a web page of the website www.nordstram.com and/or to a location within the Nordstram App to enable the user 260A to purchase the Deborah Lippmann™ Baby Love nail polish from the retailer Nordstram, Inc. For example, the deep link module 255E of the deep link provider 254 can create a user-based deep link “http://shop.nordstram.com/s/deborah-lippmann-nail-color/8675309” for user 260A in view of the user activity of user 260A. User 260A can select (e.g., click, touch, hover over, etc.) the user-based deep link 275A and be directed to the vendor digital content 273 (e.g., particular web page in the Nordstram website or particular location in the Nordstram mobile app) to purchase the Deborah Lippmann™ Baby Love nail polish from the retailer Nordstram.

In another example, the deep link module 255E of the deep link provider 254 may determine that user 260B accessed the website and/or mobile app of Vendor-B 206 (e.g., Neimint Sparkus) every day within the last week and can cause deep link 275B for user 260B to direct user 260B to a web page of the website www.neimintsparkus.com and/or to a location within the Neimint Sparkus App to enable the user 260B to purchase the same nail polish product as user 260A (e.g., Deborah Lippmann™ Baby Love nail polish), but from the retailer Neimint Sparkus, which is different from the vendor associated with user 260A. For example, the deep link module 255E of the deep link provider 254 can create a user-based deep link “http://www.neimintsparkus.com/Deborah-Lippmann-Baby-Love-Nail-Lacquer/prod123456789” for user 260B in view of the user activity of user 260B. User 260B can select (e.g., click, touch, hover over, etc.) the user-based deep link 275B and be directed to the vendor digital content 274 (e.g., particular web page in the Neimint Sparkus website or particular location in the Neimint Sparkus mobile app) to purchase the Deborah Lippmann™ Baby Love nail polish from the retailer Neimint Sparkus.

In one implementation, prior to the deep link module 255E creating a user-based deep link for a user 260, the publisher digital content (e.g., online article 270A-B) includes an initial deep link. In one implementation, the initial deep link is a static deep link that is the same for any user 260 that is accessing the publisher digital content (e.g., online article 270A-B). For example, deep link 275A and deep link 275B can be a static deep link, which, if presented to the users 260A-B, directs all of the users 260A-B to the same web page of a vendor (e.g., in-network vendor or out-of-network vendor) for purchasing the nail polish product. For example, an out-of-network vendor Sephoral may offer the nail polish product for sale on its website. The online article may be configured with an initial deep link 275A-B, which if presented to users 260A-B, directs the users 260A-B to the specific nail polish product in a web page of the Sephoral website to purchase the nail polish product. For each particular user 260A-B, the deep link module 255E of the deep link provider 254 can change the initial deep link and/or replace the initial deep link with a corresponding user-based deep link for the respective user 260A-B.

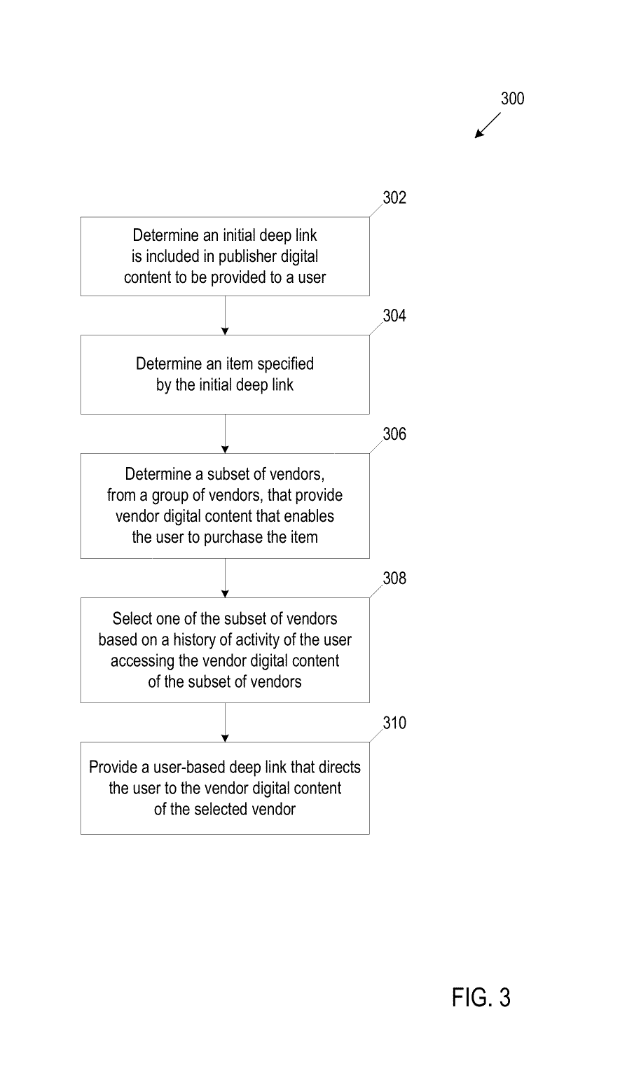

According to various implementations of the present disclosure, the deep link module 255E of the deep link provider 254 selects one of the in-network vendors 205 for a user-based deep link for a particular user 260 based on criteria data 247 that is stored in a data store 240. The criteria data 247 can specify how the deep link module 255E should select one of the in-network vendors 205. The criteria data 247 can be pre-defined and/or user-defined. The criteria data 247 can be based on, for example, and not limited to, likelihood of a particular user making a purchase with each of the available in network deep link options vendors, price of the item at each of the deep link vendors, commission of the deep link vendors upon the completion of a sale, and bid amount each of the deep link vendor to control which user-based deep link is provided to a respective user. One implementation of using the criteria data to select which of the in-network vendors for a user-based deep link is described in greater detail below in conjunction with FIG. 3.

The data stores 240 can be a persistent storage that is capable of storing data. As will be appreciated by those skilled in the art, in some implementations data store 240 might be a network-attached file server, while in other implementations data store 240 might be some other type of persistent storage such as an object-oriented database, a relational database, and so forth.

The deep link modules 255A-E may communicate with one or more of the publisher server computing machines 250 and one or more of the vendor server computing machines 210A-C, and may collect account information, personal information, and/or demographic information pertaining to particular users (e.g., vendor digital content accessed by the user, publisher digital content accessed by the user, data indicating a purchase was made by the user from a vendor, age of user, geography (e.g., country, state, city) of user) and/or groups of users (e.g., vendor digital content accessed by the user groups, publisher digital content accessed by the user groups, data indicating a purchase was made by the user groups from a vendor, age of user groups, geography (e.g., country, state, city) of user groups) and may store the information in one or more data stores (e.g., hard disks, memories, databases, etc.). In situations in which the implementations discussed herein collect personal information and/or demographic about users, or may make use of personal information and/or demographic information, the user may be provided with an opportunity to control whether the deep link modules 255A-E are allowed to collect the information (e.g., information about a user's social network, social actions or activities, profession, a user's preferences, or a user's current location), or to control whether and/or how to receive content from the deep link modules 255A-E that may be more relevant to the user. In addition, certain data may be treated in one or more ways before it is stored or used, so that personally identifiable information is removed. Thus, the user may have control over how, when, and what type of information is collected about the user and used by the deep link modules 255A-E.

FIG. 3 is a flow diagram of an implementation of a method 300 for dynamically providing deep links based on user activity of a particular user, in accordance with one or more aspects of the present disclosure. The method may be performed by processing logic that may comprise hardware (circuitry, dedicated logic, etc.), software (such as is run on a general purpose computer system or a dedicated machine), or a combination of both. In one implementation, the method 300 may be performed by the deep link module 255E on deep link server computing machine 230 in FIG. 2. In another implementation, one or more portions of method 300 may be performed by a server computing system coupled to the deep link server computing machine.

At block 302, the computing machine determines that an initial deep link is included in publisher digital content that is to be provided to a user. The computing machine can make the determination by receiving a message from a client device and/or a publisher system. The message can include the initial deep link and a request for a user-based deep link, which is a deep link customized for the particular user.

At block 304, the computing machine determines an item specified by the initial deep link. The initial deep link can include one or more item identifiers. The item can be an item (e.g., product and/or service) for purchase. The computing machine can extract an item identifier from the initial deep link.

At block 306, the computing machine determines a subset of vendors, from a group of vendors (e.g., in-network vendors), that provide vendor digital content (e.g., web page, mobile app) that enables the user to purchase the item, similar item, and/or related items, and/or enables the user to access (e.g., view) data (e.g., coupons, descriptions, reviews, comments, specifications, ingredients, ratings, recommendations, posts, etc.) pertaining the item, similar item, and/or related item(s) that pertains to the item, similar item, and/or related item(s). The computing machine can map the item identifier to vendor information that is stored in a data store that is coupled to the computing machine to determine which in-network vendors provide the item for sale, provide a similar item for sale, provide one or more related items for sale, and/or provide content (e.g., coupons, descriptions, reviews, comments, specifications, ingredients, ratings, recommendations, posts, etc.) pertaining to the item, similar item, and/or related items which a user can access, for example, via a web page or a mobile app of a respective in-network vendor.

At block 308, the computing machine selects one of the subset of vendors based on a history of activity of the user accessing the vendor digital content of the subset of vendors. The computing machine can also select one of the subset of vendors based one or more characteristic data (e.g., demographic data, in market data, interest data, affinity data, and buyer/shopper user model data) pertaining to the user. The message from the publisher system can include a user identifier for the user. For example, the user identifier can include cookie data for the user. The computing machine can use the user identifier to access user activity data that is coupled to the computing machine to determine whether any digital content (e.g., web page, mobile app) of the subset of vendors, which provide the item for sale, provide a similar item for sale, provide related items for sale, and/or provide information (e.g., coupons, descriptions, reviews, comments, specifications, ingredients, ratings, recommendations, posts, etc.) pertaining to the item, similar item, and/or related item(s) accessible to a user, has been accessed by the user.

The computing machine can use criteria data to select one of the subset of vendors. The criteria data can be based on, for example, and not limited to, likelihood of a particular user making a purchase with each of the available in network deep link options vendors, price of the item at each of the deep link vendors, commission of the deep link vendors upon the completion of a sale, and bid amount each of the deep link vendor to control which user-based deep link is provided to a respective user. In one implementation, the computing machine selects one of the subset of vendors using the following:

max_{νev}{P(u,ν)×Commission+Bid} Equation 1

where “P(u,v)” is the likelihood of the particular user making a purchase with each of the available in-network vendors, “Commission” is the commission each in-network vendor will pay to the deep link provider upon completion of a sale, and “Bid” is the amount that is bid by each of the in-network vendors to control which in-network vendor should be used for the user-based deep link.

In one implementation, the computing machine determines P(u,v) that takes into account where (e.g., web site, mobile apps) a user has shopped before, how recent the user may have shopped at a vendor, the particular user's demographic data, whether the user is “in market” for certain related items from a particular vendor, if the user fits a particular user model (e.g., buyer/shopper user model), and other user data based on targeting techniques. The computing machine can access one or more data stores (e.g., data store 240 in FIG. 2) that stores data to determine P(u,v). The deep link system can create and store one or more user models in the data store.

In one implementation, the computing machine determines P(u,v) using:

$$\begin{matrix}P ( u , v ) = PurchaseScore ( u , v ) + \\ Visit ( u , v ) + Price ( v ) + VendorScore ( v )\end{matrix} \\ where , \\ \begin{matrix}PurchaseScore ( u , v ) = {\sum }_{i ∈ item} \frac{{price}_{i}}{{time}_{I}} & Statement 1 \\ Visit ( u , v ) = {\sum }_{v ∈ visit} \frac{C}{{time}_{v}} & Statement 2 \\ where c is a configurable constant , & \\ Price ( v ) = AveragePrice - Price & Statement 3 \\ VendorScore ( v ) = reputation value & Statement 4\end{matrix} \qquad Equation 2$$

In another implementation, the criteria data specifies that the computing machine should determine which of the in-network vendors has completed a purchase transaction with a particular user and should select the in-network vendor having completed the most recent purchase transaction with the particular user.

In yet another, implementation, the criteria data specifies that the computing machine should identify the in-network vendors that have digital content accessed by a particular user, compare the time stamps of the sessions of the particular user accessing the digital content of the in-network vendors, and should select the in-network vendor having the digital content accessed most recently by the particular user.

In yet one implementation, the criteria data specifies that the computing machine should identify the in-network vendors that have digital content accessed by a particular user, compare the number of entries for the in-network vendors, and should select the in-network vendor having the digital content accessed most frequently by the particular user.

In yet one implementation, the criteria data specifies that the computing machine should select the in-network vendor that has offered a highest bid. The vendor information that is stored in the data store can include a bid from a respective in-network vendor. The bid can be a price the in-network vendor is willing to pay to have a user-based deep link in publisher digital content that directs the particular user to the vendor digital content (e.g., web page, mobile app) of the respective in-network vendor that has placed the bid.

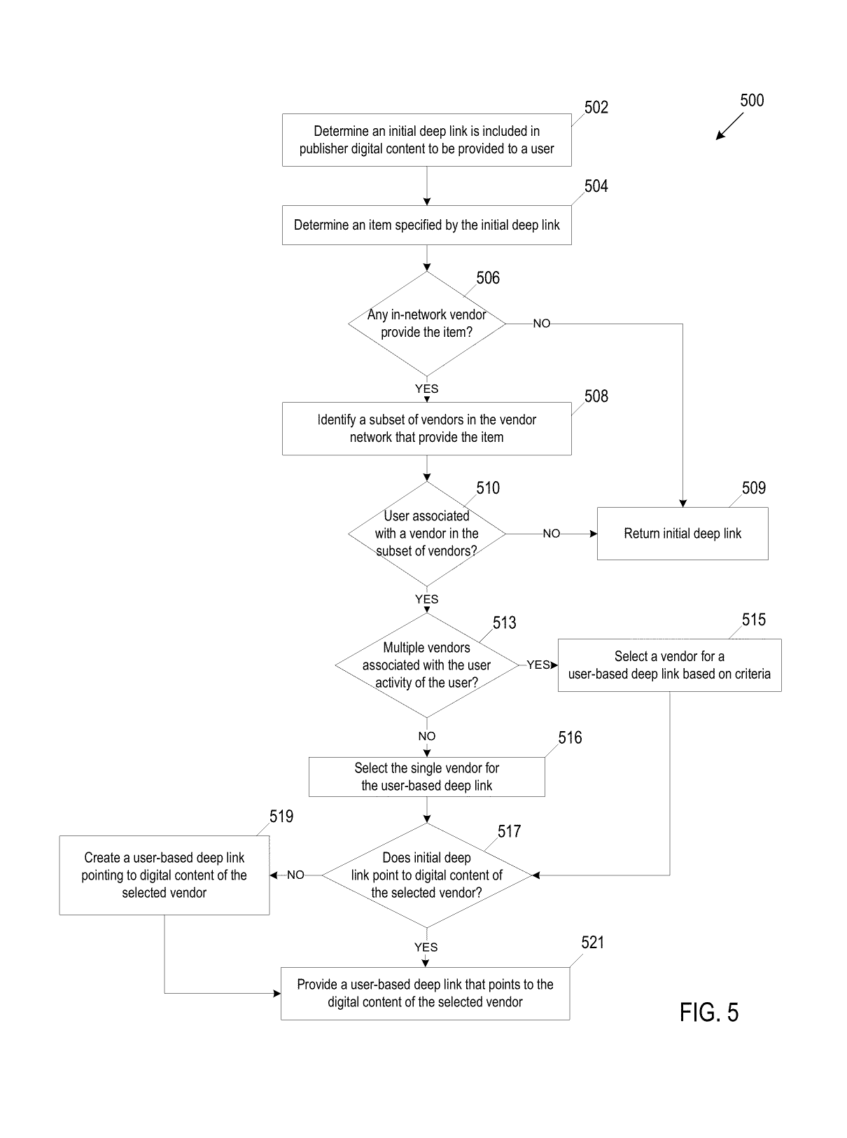

One implementation of the selection of one of the subset of vendors is described in greater detail below in conjunction with FIG. 5.

At block 310, the computing machine provides a user-based deep link, which directs the particular user to the vendor digital content of the selected vendor, for the particular user. The providing of the user-based deep link for the particular user is described in greater detail below in conjunction with FIG. 5.

FIG. 4 is a block diagram for dynamically providing deep links based on user activity of a particular user, in accordance with one or more aspects of the present disclosure. An end user can use a client device 401 (e.g., client device 265A in FIG. 2) to send (419) a request to a vendor server computing machine 402 for digital content (e.g., web page, mobile app) of the vendor. For example, the user can use a web browser to request a web page of the vendor. In another example, the user can access a mobile app of the vendor. The vendor server computing machine 402 can receive the request and provide (421) the vendor digital content (e.g., web page, mobile app) with a deep link provider tracking pixel to the client device 401. The vendor can have a relationship with the deep link provider. The deep link provider can provide a tracking pixel to the in-network vendors, which the in-network vendors can embed in the digital content (e.g., web pages, mobile app content) of the respective in-network vendor. The deep link provider tracking pixel can be used to trigger a cookie of the user, and to deliver activity data of the user directly from the client device 401 of the user to the deep link provider (e.g., deep link server computing machine 409). A tracking pixel can be an HTML (hypertext markup language) element that included in the vendor digital content (e.g., web page, mobile app) that is provided to the client device 401.

The client device 401 can store (423) a tracking cookie, on local storage (e.g., memory) on the client device 401. The tracking cookie is a piece of text, including the unique identifier for the user, which is stored on the client device 401. The tracking cookie allows a website and/or a mobile app to store cookie data pertaining to the user and the digital content (e.g., web page, mobile app) on the client device 401 and to later retrieve the cookie data. The cookie data can include, for example, and is not limited to, the unique identifier of the user, the identifier of the digital content accessed by the user, session identifier, session timestamp, and data indicating whether a purchase was made during the session.

Various applications, such as mobile apps, web browsers, etc. (not shown) can run on the client devices 401 (e.g., on the OS of the client devices) for accessing vendor digital content and publisher digital content. The application (e.g., web browser) on client device 401 can fire up the tracking pixel from the content (e.g., vendor web page) and send (424) tracking data and cookie data to the deep link module 405C in the deep link server computing machine 409. The tracking data can included, and it is not limited to, the amount of items purchased from the vendor digital content and other data indicating a user's activity with the vendor digital content.

The deep link module 405C in the deep link server computing machine 409 can store (427) the tracking data and the cookie data as part of user activity data in a data store 411 that is coupled to the deep link server computing machine 409.

The end-user may wish to access publisher digital content. For example, the end-user may wish to read an online blog post describing the top ten cooking tools for summer grilling. The client device 401 can send (429) a request and cookie data, including the user identifier of the user, to a publisher server computing machine 407 to request the web page of the online blog post. The publisher server computing machine 407 provides (431) the publisher digital content with an initial deep link to the client device 401.

The client device 401 sends (433) a message to the deep link module 405C in the deep link server computing machine 409. The message can include the cookie data, a request for a user-based deep link, the one or more initial deep links in the requested publisher digital content (e.g., web page, mobile app), the URL of the web page and meta tags. For example, the message can include the unique identifier of the user and a list of the initial deep links for the top ten cooking tools for summer grilling.

The deep link module 405C in the deep link server computing machine 409 can determine (435) the one or more initial deep links (e.g., deep links for the top ten cooking tools for summer grilling) in the publisher digital content from the message and can identify (437) the item that is specified for each of the initial deep links. Each deep link can include an item identifier. The deep link module 405C can extract the item identifier from each initial deep link.

For each initial deep link in the publisher digital content, the deep link module 405C can determine (439) a subset of vendors, from the group of in-network vendors, which offer the item for purchase, offer a similar item for purchase, offer related items for purchase, and/or offer digital content (e.g., coupons, descriptions, reviews, comments, specifications, ingredients, ratings, recommendations, posts, etc.) pertaining the item, similar item, and/or related items which the user can access. The deep link module 405C can access vendor information that is stored in the data store 411 and use the item identifier(s) to search for vendors, from the group of in-network vendors, which offer the item for purchase, offer a similar item for purchase, offer related items for purchase, and/or offer data (e.g., coupons, descriptions, reviews, comments, specifications, ingredients, ratings, recommendations, posts, etc.) pertaining the item, similar item, and/or related items which the user can access.

For each initial deep link in the publisher digital content, the deep link module 405C can select (441) one of the subset of vendors based on the user activity data of the user and/or characteristic data (e.g., demographic data, in market data, interest data, affinity data, and buyer/shopper user model data) pertaining to the user. The deep link module 405C can access the user activity data and/or characteristic data that is stored in the data store 411 and use the unique identifier of the user received in the message to determine which of the subset of vendors should be selected. One implementation of the selection of one of the subset of vendors is described above using Equation 1 and Equation 2. Another implementation of the selection of one of the subset of vendors is described in greater detail below in conjunction with FIG. 5.

Referring again to FIG. 4, the deep link module 405C identifies (443) a user-based deep link that directs the user to the selected vendor and provides (445) the user-based deep link that directs the user to the selected vendor to the client device 401. A user-based deep link is a deep link customized for a particular user. In one implementation, the user-based deep link for a particular user is based on user activity and/or characteristic data of the particular user. One implementation of the identification of the user-based deep link that directs the user to the selected vendor is described above using Equation 1 and Equation 2. Another implementation, of the identification of the user-based deep link that directs the user to the selected vendor is described in greater detail below in conjunction with FIG. 5.

In one implementation, the user activity data is collected as first party data as described above, for example, by having the deep link server computing machine 409 directly receiving tracking data and cookie data from one or more users using the tracking pixel of the deep link provider that is embedded in one or more vendor digital content of an one or more in-network vendors. For example, the deep link provider tracking pixel can be triggered on a client device 401, and the client device 401 can directly send the tracking data and the cookie data for the particular user to the deep link module 405C of the deep link server computing machine 409.

In one implementation, the user activity data is collected as second party data as described above, for example, from a second party in-network vendor and/or second party in-network publisher. For example, the deep link module 405A of the vendor server computing machine 403 can collect tracking data and cookie data of one or more users and can send the tracking data and the cookie data for the one or more users to the deep link module 405C of the deep link server computing machine 409. In another example, the deep link module 405B of the publisher server computing machine 407 can receive tracking data and cookie data of one or more users and can send the tracking data and the cookie data for the one or more users to the deep link module 405C of the deep link server computing machine 409.

In one implementation, the user activity data is collected as third party data. In-network vendors and/or in-network publisher may utilize a third party data aggregator to collect information for individual users indicating whether individual users have accessed digital content of the in-network vendors and/or in-network publishers. The deep link module 405C of the deep link server computing machine 409 can receive the information from the third party data aggregator. The deep link module 405C of the deep link server computing machine 409 can periodically request the information from the third party data aggregator. Alternatively, the third party data aggregator can periodically send the information to the deep link module 405C.

FIG. 5 is a flow diagram of an implementation of a method 500 for selecting an in-network vendor based on user activity of a particular user, in accordance with one or more aspects of the present disclosure. The method may be performed by processing logic that may comprise hardware (circuitry, dedicated logic, etc.), software (such as is run on a general purpose computer system or a dedicated machine), or a combination of both. In one implementation, the method 500 may be performed by the deep link module 255E on deep link server computing machine 230 in FIG. 2. In another implementation, one or more portions of method 500 may be performed by a server computing system coupled to the deep link server computing machine.

At block 502, the computing machine determines that an initial deep link is included in publisher digital content that is to be provided to a user. The computing machine can make the determination by receiving a message from a client device. The message can include the initial deep link and a user identifier (e.g., cookie data) for the user.

At block 504, the computing machine determines an item that is specified by the initial deep link. The initial deep link can include one or more item identifiers. The computing machines can parse the initial deep link in the message and extract an item identifier from the initial deep link. In one implementation, the computing machine uses one or more regular expressions, which are sequences of characters that form a search pattern, to locate one or more identifiers for an item in the initial deep link. For example, the initial deep link may be http://www.sephoral.com/nail-lacquer-sheer-P521056 and the computing machine may locate a type of product, “nail-lacquer-sheer” and a product number “P521056”.

At block 506, the computing machine determines whether any vendor in a group of in-network vendors provides vendor digital content (e.g., web page, mobile app) that enables the user to purchase the item, purchase a similar item, purchase one or more related items, and/or enables the user to access information (e.g., descriptions, reviews, comments, specifications, ratings, etc.) pertaining the item, similar item, and/or related item(s). The computing machine can access vendor information that is stored in a data store and search for any in-network vendors that offer the item, similar item, and/or related item(s) for sale, and/or content (e.g., coupons, descriptions, reviews, comments, specifications, ingredients, ratings, recommendations, posts, etc.) pertaining to the item, similar item, and/or related item(s). The vendor information can include information for the in-network vendors. The vendor information can include item identifiers of items, which the in-network vendors offer for sale, for example, via a web page, or a mobile app of a respective vendor, similar items, related items, and information (e.g., coupons, descriptions, reviews, comments, specifications, ingredients, ratings, recommendations, posts, etc.) pertaining to the item, similar item, and/or related item(s). The computing machine can determine whether any item identifiers, for example, of items, similar item(s), and/or related item(s), in the vendor information match and/or are associated with the item identifier(s) in the initial deep link. In one example, the item identifier in the initial deep link may not directly match the item identifier(s) in the vendor information, and the computing machine can locate item identifiers that are the closest match to the item identifier(s) in the initial deep link and correspond to the same item that is specified in the initial deep link, correspond to one or more items that are similar to the item that is specified in the initial deep link, and/or correspond to one or more items that are related to the item that is specified in the initial deep link.

If there is no vendor in the group of in-network vendors that provides the item, similar item, and/or related item for purchase (block 506), related content of equal or more value, and/or content (e.g., coupons, descriptions, reviews, comments, specifications, ingredients, ratings, recommendations, posts, etc.) pertaining to the item, similar item, and/or related item, the computing machine returns the initial deep link to the publisher system at block 521. If there is one or more vendors in the group of in-network vendors that provide the item similar item, and/or related item for purchase, related content of equal or more value, and/or content (e.g., coupons, descriptions, reviews, comments, specifications, ingredients, ratings, recommendations, posts, etc.) pertaining to the item, similar item, and/or related item (block 506), the computing machine identifies the subset of vendors in the group of in-network vendors that provide the item, similar item, and/or related item for purchase, related content of equal or more value, and/or content (e.g., coupons, descriptions, reviews, comments, specifications, ingredients, ratings, recommendations, posts, etc.) pertaining to the item, similar item, and/or related item at block 508. The computing machine can select the item identifiers in the vendor information that match and/or map to the item identifier(s) in the initial deep link and determine the vendor identifiers that correspond to the selected item identifiers.

At block 510, the computing machine determines whether the user is associated with at least one of the subset of vendors and identifies which of the subset of vendors that the user is associated with. The message from the client device can include a user identifier (e.g., cookie data) for the user. The computing machine can access user activity data that is stored in a data store that is coupled to the computing and search for user activity data that matches the user identifier received in the message. The user activity data can include data for multiple users. The user activity data can include multiple entries for each user. Each entry can correspond to a session of a user accessing vendor digital content (e.g., web page, mobile app). Each entry can include the unique identifier of a respective user, the identifier of the digital content accessed by the respective user, session identifier for the particular session, session timestamp for the particular session, and data indicating whether a purchase was made during the particular session.

The computing machine can identify one or more entries that match the user identifier, determine which vendor(s) correspond to the digital content (e.g., web page, mobile app) in the identified entries, and determine if any of the corresponding vendors are from the subset of vendors that offer the item, similar item, and/or related item for purchase, related content of equal or more value, and/or content (e.g., coupons, descriptions, reviews, comments, specifications, ingredients, ratings, recommendations, posts, etc.) pertaining to the item, similar item, and/or related item.

If the user is not associated with any vendor in the subset of vendors (block 510), the computing machine returns the initial deep link to the publisher system at block 521. If the user is associated with one or more vendors in the subset of vendors (block 510), the computing machine determines whether there are multiple vendors in the subset of in-network vendors that are associated with the user activity of the user at block 513.

If there are not multiple vendors in the subset of in-network vendors that are associated with the user activity of the user, the computing machine selects the single vendor for a user-based deep link at block 516. If there are multiple vendors in the subset of in-network vendors that are associated with the user activity of the user, the computing machine selects one of the subset of in-network vendors for a user-based deep link based on criteria at block 515. One implementation of selecting the single vendor for a user-based deep link is described above using Equation 1 and Equation 2.

The computing machine can access criteria data that is stored in a data store that is coupled to the computing machine. The criteria data can specify how the computing machine should select one of the subset of in-network vendors. The criteria data can be based on, for example, and not limited to, likelihood of a particular user making a purchase with each of the available in network deep link options vendors, price of the item at each of the deep link vendors, commission of the deep link vendors upon the completion of a sale, and bid amount each of the deep link vendor to control which user-based deep link is provided to a respective user. One implementation of selecting the single vendor for a user-based deep link using criteria data is described above using Equation 1 and Equation 2. In other implementations, the criteria data can specify the computing machine to select the in-network vendor of the subset of vendors having completed the most recent purchase transaction with the particular user, select the in-network vendor of the subset of vendors having the digital content accessed most recently by the particular user, select the in-network vendor of the subset of vendors having the digital content accessed most frequently by the particular user, select the in-network vendor of the subset of vendors that has offered a highest bid, and/or a combination of such.

When a vendor is selected (block 516 or block 515), the computing machine determines whether the initial deep link in the publisher digital content points to the digital content (e.g., web page, mobile app) of the selected vendor. The computing machine can extract information from the initial deep link to determine the vendor that is associated with the initial deep link. For example, the initial deep link can include a vendor identifier and the computing machine can use regular expressions to parse the initial deep link to extract the vendor identifier. For example, the initial deep link may be http://www.sephoral.com/nail-lacquer-sheer-P521056 and the computing machine can extract “sephoral” as the vendor identifier from the initial deep link. The computing machine can determine whether the vendor that is associated with the initial deep link matches the selected vendor to determine whether the initial deep link points to the digital content of the selected vendor.

If the computing machine determines that the initial deep link directs the end-user to the digital content of the selected vendor (block 517), the computing machine returns the initial deep link as a user-based deep link to the publisher system at block 521. If the computing machine determines that the initial deep link does not direct the end-user to the digital content of the selected vendor (block 517), the computing machine creates a user-based deep link that directs the end-user to the digital content of the selected vendor at block 519. In one implementation, the computing machine modifies the initial deep link to direct the end-user to the digital content of the selected vendor. The computing machine can replace the vendor identifier and/or item identifier(s) in the initial deep link with the vendor identifier and item identifier(s) corresponding to the selected vendor. The computing machine can determine which vendor identifier and item identifier(s) to use from the vendor information in the data store. The computing machine can modify the initial deep link to direct the user to the digital content of the selected vendor that enables the user to purchase the item from the selected vendor.

At block 521, the computing machine provides the user-based deep link. In one implementation, the computing machine provides the modified deep link (e.g., user-based deep link) to the client device. In another implementation, the computing machine provides the modified deep link to the publisher system, and the publisher system can provide the modified deep link (e.g., user-based deep link) to the client device.

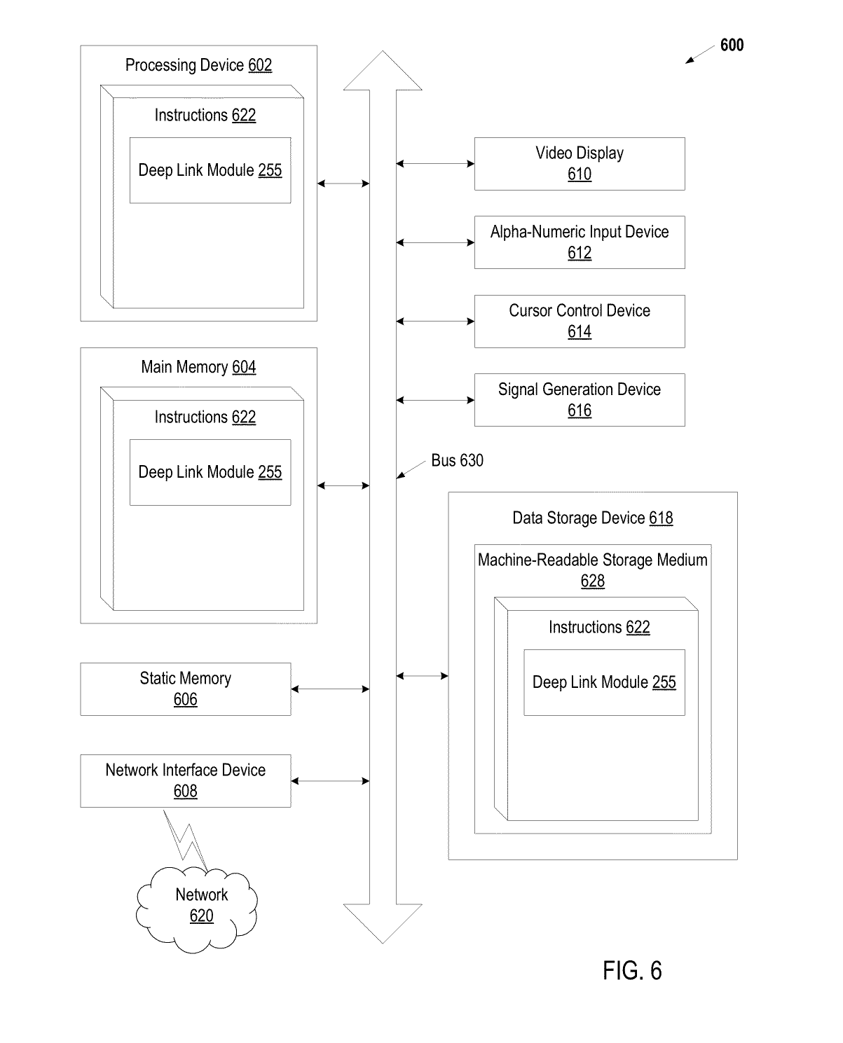

FIG. 6 illustrates a diagram of a machine in an example form of a computer system 600 within which a set of instructions, for causing the machine to perform any one or more of the methodologies discussed herein, may be executed. The computer system 600 can be deep link server computing machine 230 in FIG. 2, vendor server computing machine 210 in FIG. 2, and/or publisher server computing machine 250 in FIG. 2. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 618, which communicate with each other via a bus 630.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 622 for performing the operations and steps discussed herein.

The computer system 600 may further include a network interface device 608. The computer system 600 also may include a video display unit 610 (e.g., a liquid crystal display (LCD) or a cathode ray tube (CRT)), an input device 612 (e.g., a keyboard, and alphanumeric keyboard, a motion sensing input device), a cursor control device 614 (e.g., a mouse), and a signal generation device 616 (e.g., a speaker).

The data storage device 618 may include a computer-readable storage medium 628 on which is stored one or more sets of instructions 622 (e.g., software) embodying any one or more of the methodologies or functions described herein. The instructions 622 may also reside, completely or at least partially, within the main memory 604 and/or within the processor 602 during execution thereof by the computer system 600, the main memory 604 and the processor 602 also constituting computer-readable storage media. The instructions 622 may further be transmitted or received over a network 620 via the network interface device 608.

In one implementation, the instructions 622 include instructions for a deep link module (e.g., deep link module 255 in FIG. 2) and/or a software library containing methods that call the deep link module. While the computer-readable storage medium 628 (machine-readable storage medium) is shown in an exemplary implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “selecting”, “providing”, “modifying”, “identifying”, “receiving”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods are depicted and described herein as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus may be constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.” Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
determining that an initial deep link is included in publisher digital content to be provided to a user by a publisher, wherein the initial deep link specifies an item;
determining a subset of vendors, from a group of vendors, that provide vendor digital content that enables the user to purchase the item, the group of vendors having a relationship with a deep link provider;
selecting one of the subset of vendors based on a history of activity of the user accessing the vendor digital content of the subset of vendors; and
providing, by a processing device, a user-based deep link for the publisher digital content, wherein the user-based deep link directs the user to the vendor digital content of the selected vendor.

2. The method of claim 1, wherein providing the user-based deep link for the publisher digital content comprises:
determining that the initial deep link in publisher digital content does not direct the user to the vendor digital content of the selected vendor;
modifying the initial deep link to direct the user to vendor digital content that enables the user to purchase the item from the selected vendor; and
providing the modified deep link to a client device.

3. The method of claim 1, wherein providing the user-based deep link for the publisher digital content comprises:
determining that the initial deep link in publisher digital content directs the user to the vendor digital content of the selected vendor; and
providing the initial deep link to a client device.

4. The method of claim 1, wherein selecting one of the one or more vendors comprises:
determining which of the one or more vendors has completed a purchase transaction with the user; and
selecting a vendor having completed a most recent purchase transaction with the user.

5. The method of claim 1, wherein selecting one of the one or more vendors comprises:
selecting a vendor having vendor digital content accessed most recently by the user.

6. The method of claim 1, wherein selecting one of the one or more vendors comprises:
selecting a vendor having vendor digital content accessed most frequently by the user within a time period.

7. The method of claim 1, wherein selecting one of the one or more vendors comprises:
identifying a plurality of the vendors having vendor digital content accessed by the user prior to the user requesting the publisher digital content from the publisher;
receiving a bid from each of the plurality of vendors; and
selecting a vendor based on the bids from the plurality of vendors.

8. A system comprising:
a memory to store a history of activity of a user accessing vendor digital content of a subset of vendors; and
a processing device coupled with the memory to:
determine that an initial deep link is included in publisher digital content to be provided to a user by a publisher, wherein the initial deep link specifies an item;
determine a subset of vendors, from a group of vendors, that provide vendor digital content that enables the user to purchase the item, the group of vendors having a relationship with a deep link provider;
select one of the subset of vendors based on the history of activity of the user accessing the vendor digital content of the subset of vendors; and
provide a user-based deep link for the publisher digital content, wherein the user-based deep link directs the user to the vendor digital content of the selected vendor.

9. The system of claim 8, wherein to provide the user-based deep link for the publisher digital content comprises the processing device to:
determine that the initial deep link in publisher digital content does not direct the user to the vendor digital content of the selected vendor;
modify the initial deep link to direct the user to vendor digital content that enables the user to purchase the item from the selected vendor; and
provide the modified deep link to a client device.

10. The system of claim 8, wherein to provide the user-based deep link for the publisher digital content comprises the processing device to:
determine that the initial deep link in publisher digital content directs the user to the vendor digital content of the selected vendor; and
provide the initial deep link to a client device.

11. The system of claim 8, wherein to select one of the one or more vendors comprises the processing device to:
determine which of the one or more vendors has completed a purchase transaction with the user; and
select a vendor having completed a most recent purchase transaction with the user.

12. The system of claim 8, wherein to select one of the one or more vendors comprises the processing device to:
select a vendor having vendor digital content accessed most recently by the user.

13. The system of claim 8, wherein to select one of the one or more vendors comprises the processing device to:
select a vendor having vendor digital content accessed most frequently by the user within a time period.

14. The system of claim 8, wherein to select one of the one or more vendors comprises the processing device to:
identify a plurality of the vendors having vendor digital content accessed by the user prior to the user requesting the publisher digital content from the publisher;
receive a bid from each of the plurality of vendors; and
select a vendor based on the bids from the plurality of vendors.

15. A non-transitory computer readable storage medium encoding instructions thereon that, in response to execution by a processing device, cause the processing device to perform operations comprising:
determining that an initial deep link is included in publisher digital content to be provided to a user by a publisher, wherein the initial deep link specifies an item;
determining a subset of vendors, from a group of vendors, that provide vendor digital content that enables the user to purchase the item, the group of vendors having a relationship with a deep link provider;
selecting one of the subset of vendors based on a history of activity of the user accessing the vendor digital content of the subset of vendors; and
providing, by the processing device, a user-based deep link for the publisher digital content, wherein the user-based deep link directs the user to the vendor digital content of the selected vendor.

16. The non-transitory computer readable storage medium of claim 15, wherein providing the user-based deep link for the publisher digital content comprises:
determining that the initial deep link in publisher digital content does not direct the user to the vendor digital content of the selected vendor;
modifying the initial deep link to direct the user to vendor digital content that enables the user to purchase the item from the selected vendor; and
providing the modified deep link to a client device.

17. The non-transitory computer readable storage medium of claim 15, wherein providing the user-based deep link for the publisher digital content comprises:
determining that the initial deep link in publisher digital content directs the user to the vendor digital content of the selected vendor; and
providing the initial deep link to a client device.

18. The non-transitory computer readable storage medium of claim 15, wherein selecting one of the one or more vendors comprises:
determining which of the one or more vendors has completed a purchase transaction with the user; and
selecting a vendor having completed a most recent purchase transaction with the user.

19. The non-transitory computer readable storage medium of claim 15, wherein selecting one of the one or more vendors comprises:
selecting a vendor having vendor digital content accessed most recently by the user.

20. The non-transitory computer readable storage medium of claim 15, wherein selecting one of the one or more vendors comprises:
identifying a plurality of the vendors having vendor digital content accessed by the user prior to the user requesting the publisher digital content from the publisher;
receiving a bid from each of the plurality of vendors; and
selecting a vendor based on the bids from the plurality of vendors.
